(19) United States
(12) Patent Application Publication
(10) Pub. No.: US 2006/0285615 A1
(43) Pub. Date: Dec. 21, 2006

(54) Sinusoidal carrier synthesis apparatus and method

(75) Inventors: Donald T. Comer, Mapleton, UT (US); Justin Fitzpatrick, Pleasant Grove, UT (US)

Correspondence Address: UTAH VALLEY PATENT SERVICES, LLC, 846 S. 1350 E., PROVO, UT, 84606, US

(73) Assignee: UltraDesign, LLC

(21) Appl. No.: 11/153,298

(22) Filed: Jun. 15, 2005

(51) Int. Cl. H04L 7/00

(52) U.S. Cl. 375/354

(57) ABSTRACT

A substantially pure sinusoidal carrier is produced by a digital-to-analog converter that repeatedly converts a sequence of N digital values provided by a digital sequencer to a stream of quantized analog samples. In certain embodiments, the N digital values comprise a time-domain function selected to substantially eliminate all odd harmonics between 1 and N-1 and all even harmonics from the stream of quantized analog samples. A filter may be used to eliminate additional unwanted harmonics. In some embodiments, the frequency of the carrier is selected by controlling the sequence rate of the digital sequencer via a programmable clock. The present invention synthesizes a harmonically pure and stable carrier of a selected frequency while enabling use of a low-resolution digital-to-analog converter.

### BACKGROUND OF THE INVENTION

1. Field of the Invention

This invention relates generally to electronic communication systems and more particularly relates to means and methods for synthesizing and modulating carrier signals within communication systems.

2. Description of the Related Art

Communication systems often use modulation and filtering to shift the frequency range of a signal and thereby facilitate processing and/or transmission of signals within an appropriate range of frequencies. For example, audio signals may be up-converted into a high frequency broadcast spectrum by modulating the audio signal with a high frequency carrier and filtering the modulated signal with a bandpass filter corresponding to the broadcast spectrum. Subsequently, the high frequency broadcast signal may be down-converted by modulating the signal with the same high frequency carrier and filtering the modulated signal with a filter corresponding to the original spectrum of the audio signal. The reader is referred to “Signals and Systems” by Oppenheim and Wilsky (Prentice-Hall 1996) for an overview of modulation, filtering, and frequency analysis.

The ability to fully utilize a broadcast spectrum depends on the harmonic purity and stability of the carrier signal as well as the ability to precisely tune the carrier signal to a desired carrier frequency. For example, a carrier containing unwanted harmonics (i.e. spurs) may result in the transmission and/or reception of ‘ghost’ signals on channels other than their intended channel.

Historically, various support circuits such as phase-locked loops and filters have been used to reduce spurs, tune to a selected carrier frequency, and stabilize a carrier to acceptable tolerances. In addition, an intermediate frequency is often used to reduce the bandwidth requirements on the modulation components and increase the attainable range of broadcast frequencies. While practical, the components needed to support an intermediate frequency, and purify and stabilize carriers increase the complexity of communication systems.

Recently, a technique known as Direct Digital Synthesis has leveraged the stability of digital circuits to provide a stable and harmonically pure carrier signal at a selectable frequency resulting in good spectrum utilization and control at relatively low cost. FIG. 1 depicts a common application of such a circuit within a wireless receiver 100. The reader is referred to http://www.radio-electronics.com/info/receivers/synth basics/dds.php for a tutorial on Direct Digital Synthesis.

The depicted wireless receiver 100 includes a frequency selection register 110, a phase summer 120, a phase accumulator 130, a waveform table 140, a digital-to-analog converter 150, an antenna 160, an amplifier 170, a modulator 180, and a filter 190. The wireless receiver 100 facilitates direct wireless reception without requiring an intermediate modulation frequency.

The frequency selection register 110 receives and stores a desired carrier frequency 102. In the depicted embodiment, the desired carrier frequency 102 corresponds to a desired phase slope (or phase difference) 112. The phase summer 120 sums a current phase 132 (provided by the phase accumulator 130) with the phase difference 112 and provides an updated phase 122 to the phase accumulator 130. The interaction of the described components results in a phase signal 132 of a selected slope 112.

The waveform table 140 maps the phase signal 132 to a digital carrier signal 142. In one embodiment, the waveform table 140 contains a sampled sine wave and the carrier signal 142 is essentially sinusoidal. The digital-to-analog converter 150 converts the digital carrier signal 142 to an analog carrier signal 152. To reduce system cost, the bits of resolution supported by the waveform table 140 and the digital-to-analog converter 150 may be less than the resolution supported by the phase summer 120 and the phase accumulator 130.

In the depicted embodiment, the antenna 160 provides a broadcast spectrum 162 to the amplifier 170. The amplifier 170 amplifies the broadcast spectrum 162 to provide a broadcast signal 172. Furthermore, the modulator 180 modulates the broadcast signal 172 with the analog carrier signal 152 to provide a frequency shifted broadcast signal 182. The frequency shifted broadcast signal 182 may be filtered by the filter 190 to provide a received signal 192. In some embodiments, a pre-modulation filter is used to remove unwanted harmonics from the analog carrier signal 152 previous to modulating the broadcast signal 172.

The overall purity of the (unfiltered) analog carrier signal 152 and the received signal 192 is determined primarily by the bits of resolution supported by various components—particularly the digital-to-analog converter 150. For example, to reduce carrier noise 60 dB below the carrier signal (i.e. −60 dBc) typically requires a digital-to-analog converter 150 with at least 10 bits of resolution. More bits may be required if a less than full-scale carrier signal is needed. At high carrier frequencies such as those exceeding 400 MHz, the required resolution may significantly increase the cost of the wireless receiver 100 and render the system impractical for use.

Furthermore, the strength of the various spurs present in the analog carrier signal 152 may be dependent on the selected frequency of the carrier signal. For example, the operating frequency of the phase accumulator 130 and the digital-to-analog converter 150 will typically not be synchronous to the carrier frequency resulting in a beat frequency (within the phase signal 122) that splits the analog carrier signal 152 into two frequency shifted sidebands. At relatively low carrier frequencies the frequency shift is typically insignificant. However, at high carrier frequencies the limited resolution of the depicted components may result in a frequency shift that is unacceptable.

From the foregoing discussion, it should be apparent that a need exists for an apparatus and method for synthesizing a sinusoidal waveform of high purity using lower resolution digital-to-analog converters. Beneficially, such an apparatus and method would enable cost effective deployment of high frequency communications.

### SUMMARY OF THE INVENTION

The present invention has been developed in response to the present state of the art, and in particular, in response to the problems and needs in the art that have not yet been fully solved by currently available carrier synthesis means and methods. Accordingly, the present invention has been developed to provide an apparatus and method for synthesizing a sinusoidal carrier that overcome many or all of the above-discussed shortcomings in the art.

In a first aspect of the present invention, a method for synthesizing a sinusoidal carrier includes providing a sequence of N digital values comprising a time-domain function selected to substantially eliminate all even harmonics and a plurality of odd harmonics from the stream of quantized analog samples, and repeatedly converting the sequence of N digital values to a stream of quantized analog samples. The method may also include providing the digital values synchronous with a programmable clock and filtering the stream of quantized analog samples to provide a substantially pure sinusoidal waveform.

In contrast to the prior art, the presented method substantially eliminates unwanted harmonics from a synthesized carrier by using a time-domain function that cancels approximation errors within a single carrier period. In certain embodiments, N is less than 17 and all even harmonics as well as all odd harmonics between 1 and N-1 are reduced more than 30 db below the synthesized carrier (i.e. −30 dBc). In some embodiments, repeated values and/or reused values are included in the sequence in order to reduce the number of unique values. Reducing the number of unique values may reduce the errors associated with approximating an ideal numeric sequence with a discrete digital value sequence suitable for use with a standard digital-to-analog converter.

In certain embodiments, the digital value sequence is of length 8 and the 3^{rd}, 5^{th}, and all even harmonics are suppressed more than 40 dBc using a 4 bit DAC. In some embodiments, the sequence of N digital values comprises two vertically mirrored subsequences. In one embodiment, the sequence of digital values corresponds to a zero offset pattern selected from the group consisting of {3,7,7,3,−3,−7,−7,−3 }, {0,5,7,5,0,−5,−7,−5}, and {0,7,10,7,0,−7,−10,−7}.

In another aspect of the present invention, an apparatus for synthesizing a sinusoidal carrier includes a digital sequencer configured to repeatedly provide a sequence of N digital values wherein the sequence of N digital values comprise a time-domain function selected to substantially eliminate all even harmonics and a plurality of odd harmonics from the stream of quantized analog samples, and a digital-to-analog converter configured to repeatedly convert the sequence of N digital values to a stream of quantized analog samples. The apparatus may also include a programmable clock configured to control the clock rate of the digital sequencer, and a filter configured to further suppress unwanted harmonics from the stream of quantized analog samples in order to provide a substantially pure sinusoidal carrier.

In certain embodiments, the digital-to-analog converter is a multiplying DAC that may receive a reference signal. The present invention may utilize an input signal as the reference signal and leverage the multiplication feature of the DAC to modulate the input signal with the carrier (as approximated by the sequence of digital values). Carrier approximation errors are substantially eliminated within a single carrier period by selecting a time-domain function that cancels such errors.

The present invention substantially eliminates phase beating and enables the use of a low-resolution digital-to-analog converter when synthesizing a sinusoidal carrier of high spectral purity. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The aforementioned features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a prior art wireless receiver;

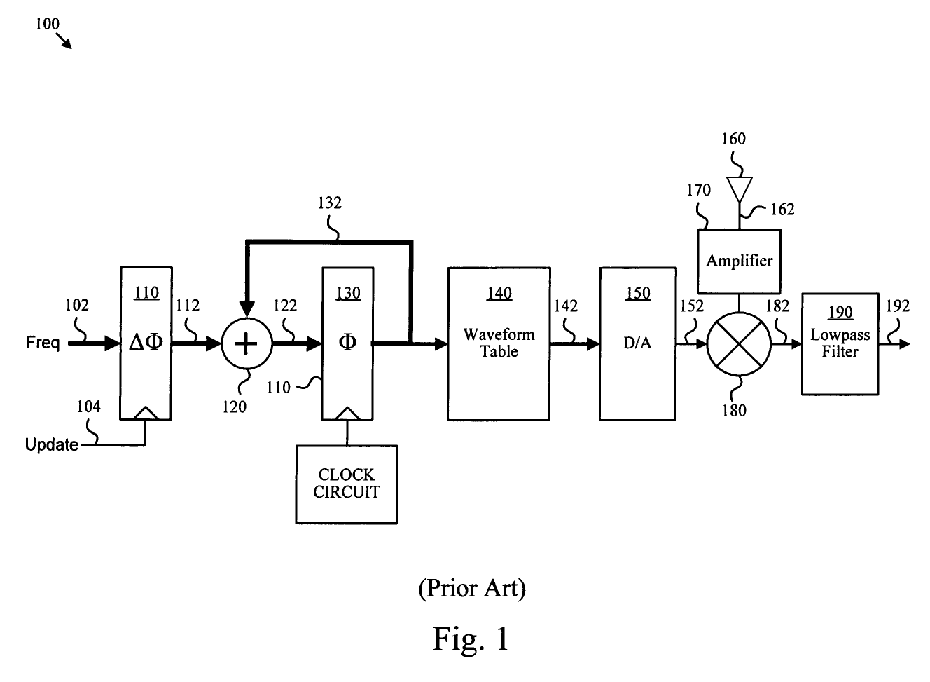

FIG. 2 is a schematic block diagram illustrating one embodiment of a carrier synthesizer of the present invention;

FIG. 3 is a schematic block diagram illustrating one embodiment of a carrier synthesis method of the present invention;

FIG. 4 is a signal diagram depicting one embodiment of a digital value sequence of the present invention;

FIG. 5 is a signal diagram depicting another embodiment of a digital value sequence of the present invention;

FIG. 6 is a digital logic schematic and associated timing diagram depicting one embodiment of a digital sequencer of the present invention; and

FIG. 7 is a digital logic schematic and associated timing diagram depicting another embodiment of a digital sequencer of the present invention.

### DETAILED DESCRIPTION OF THE INVENTION

Some of the functional units described in this specification have been explicitly labeled as modules while others are assumed to be modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

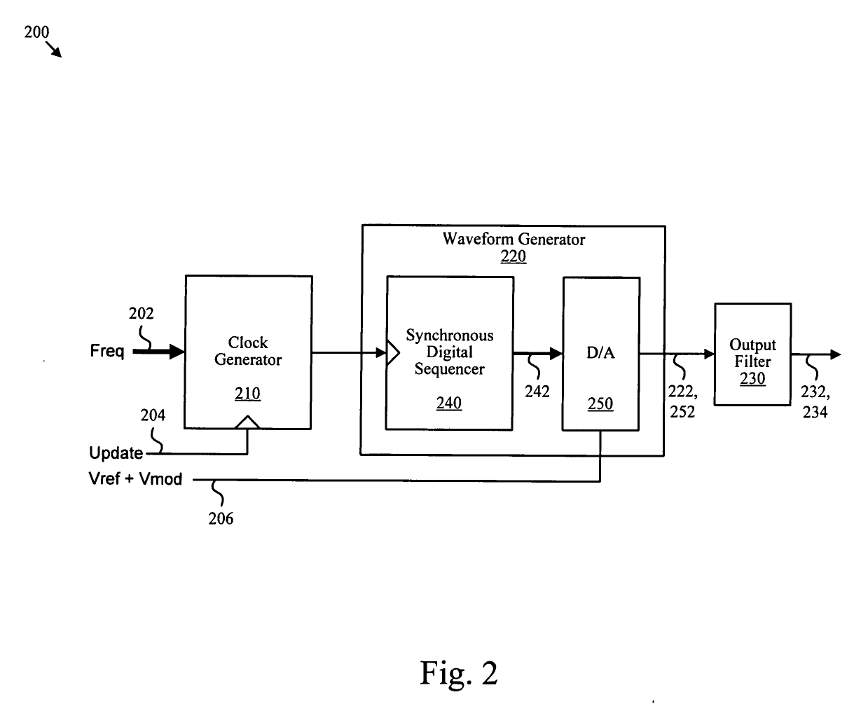

FIG. 2 is a schematic block diagram illustrating one embodiment of a carrier synthesizer 200 of the present invention. As depicted, the carrier synthesizer 200 includes a clock generator 210, a waveform generator 220, and an output filter 230. The carrier synthesizer 200 suppresses unwanted harmonics or spurs from a carrier while enabling usage of a low-resolution digital-to-analog converter (DAC).

The clock generator 210 generates a clock signal of a selected frequency. In the depicted embodiment, the selected frequency is programmable via the desired frequency 202 and the update clock 204. In another embodiment, the clock generator 210 is fixed at a selected frequency. Using a separate clock generator 210 to control the desired frequency 202 reduces the complexity of the present invention over previous solutions and enables use of low resolution components.

The depicted waveform generator 220 generates a quantized carrier 222. In the depicted embodiment, the quantized carrier 222 is also modulated by an input signal 206. In one embodiment, the input signal 206 is a reference signal provided by a fixed voltage source. In another embodiment, the input signal 206 includes a modulation signal such as a received broadcast signal. The output filter 230 filters the quantized carrier 222 to provide a pure carrier 232 or a modulated signal 234 (in those cases where the input signal 206 is not fixed).

The depicted waveform generator 220 includes a synchronous digital sequencer 240 and digital-to-analog converter 250. The synchronous digital sequencer 240 may repeatedly provide a sequence of digital values 242 to the digital-to-analog converter 250. In turn, the digital-to-analog converter 250 converts the digital values 242 to provide a stream of quantized analog samples 252 that collectively comprise the quantized carrier 222. In contrast to Direct Digital Synthesis, carrier quantization or approximation errors are substantially eliminated by the present invention within a single carrier period by generating a stream of quantized analog samples 252 that cancels such errors.

The digital values 242 may be a fixed sequence of length N that are repeatedly provided by the synchronous digital sequencer 240. In one embodiment, the synchronous digital sequencer 240 is a state machine capable of operating at very high clock rates. The digital values 242 may be selected to substantially eliminate all even harmonics and multiple odd harmonics from the quantized carrier 222. In one embodiment, all odd harmonics between 1 and N-1 are suppressed more than 30 dB below the fundamental carrier (1^{st} harmonic). The output filter 230 may further suppress unwanted harmonics.

The schematic flow chart diagrams that follow are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the order in which a particular method occurs may or may not strictly adhere to the order of the corresponding operations shown.

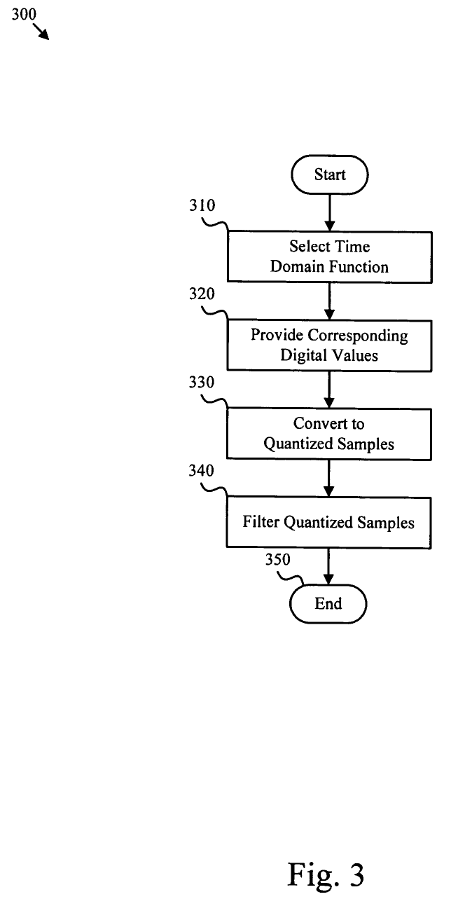

FIG. 3 is a schematic block diagram illustrating one embodiment of a carrier synthesis method 300 of the present invention. As depicted, the carrier synthesis method 300 includes selecting 310 a time domain function, providing 320 corresponding digital values, converting 330 the digital values to quantized samples, and filtering 340 the quantized samples. The carrier synthesis method 300 facilitates the synthesis of a high frequency sinusoidal carrier. In certain embodiments, the method 300 may also modulate a selected signal with the synthesized carrier.

Selecting 310 a time domain function facilitates selecting the harmonic content of the synthesized carrier while reducing the required resolution of digital-to-analog conversion. In one embodiment, the time domain function is partitioned into segments of constant amplitude (i.e. the digital values 242) and Fourier equations representing the harmonic content of the time domain function are solved (by setting selected harmonics to zero) to determine the ideal amplitude relationships of the time domain segments.

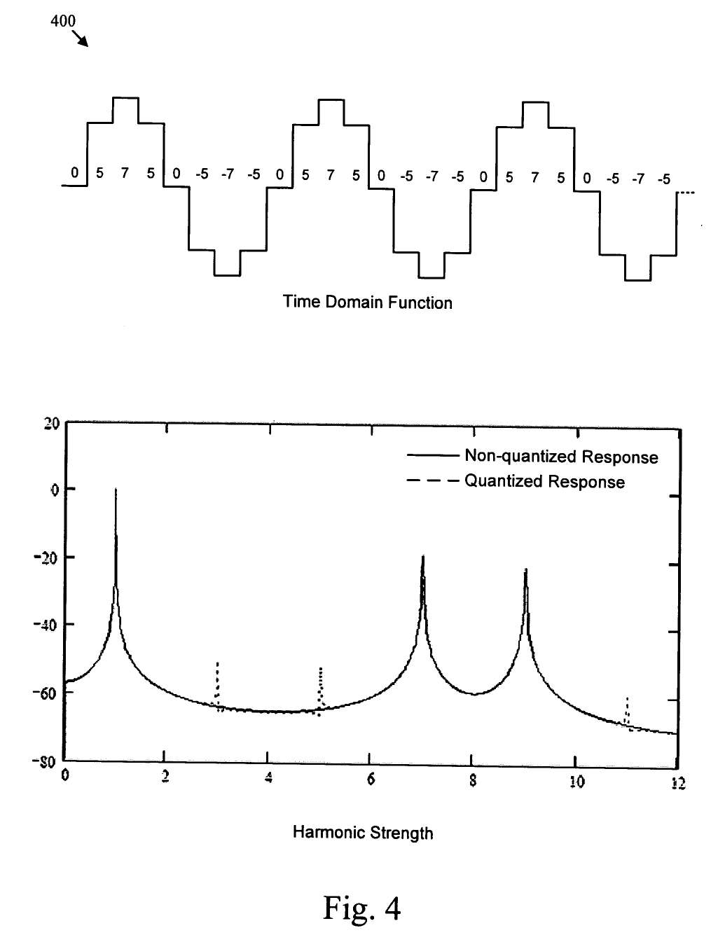

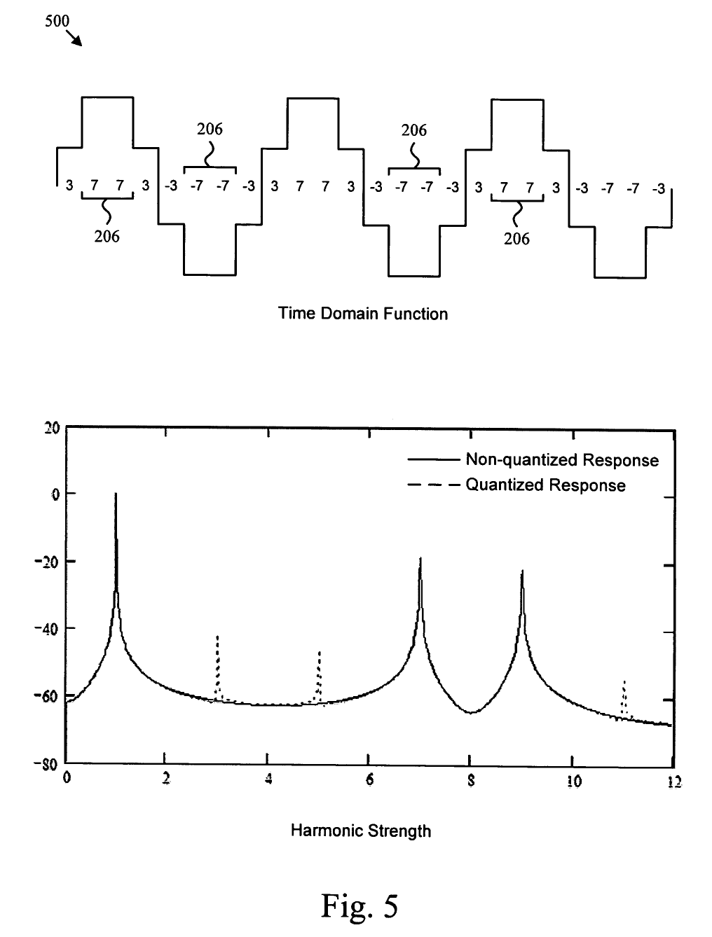

The amplitudes of the time domain function corresponding to the digital values 242 may be selected to substantially eliminate all even harmonics and multiple odd harmonics from the corresponding quantized signal (such as the quantized carrier 222). In one embodiment, the time domain function is segmented into N segments and all odd harmonics between 1 and N-1 are set to zero in the Fourier equations. FIGS. 4 and 5 depict specific examples of such an embodiment.

Specific constraints on the time domain function may reduce or cancel quantization error. For example, minimizing the number of unique amplitudes in the time domain function reduces the number of amplitude relationships and provides more degrees of freedom in scaling the time domain function to match to quantized values. Consequently, reducing the number of unique amplitudes in the time domain function enables utilization of a lower resolution digital-to-analog converter. In certain embodiments, a time domain function partitioned into N constant amplitude segments includes less than N/2 unique amplitudes. In some embodiments, adjacent segments are constrained to the same amplitude.

Subsequent to selecting 310 a time domain function that substantially cancels carrier approximation errors and thereby suppresses unwanted harmonics, the carrier synthesis method 300 proceeds by providing 320 corresponding digital values such as the digital values 242. In certain embodiments, the ideal amplitude relationships of the selected time domain function are scaled to align with digital (i.e. integer) values and thereby minimize quantization error within the resulting analog signal. In one embodiment, the digital values are provided at a high clock rate via a digital logic circuit such as a state machine.

The depicted carrier synthesis method 300 proceeds by converting 330 the digital values to quantized samples, and filtering 340 the quantized samples. In certain embodiments, a 4-bit DAC is used in converting 330 the digital values to quantized samples. In some embodiments, a multiplying DAC is used in converting 330 the digital values to quantized samples and the amplitude of the quantized samples may be scaled or modulated by using a selected signal as the reference signal.

In one embodiment, filtering 340 the quantized samples occurs by filtering with a lowpass filter having a zero corresponding to a specific harmonic (such as harmonic N-1). Using a lowpass filter enables suppression of additional unwanted harmonics from the synthesized carrier. Subsequent to filtering, the depicted method ends 350.

FIGS. 4 and 5 are signal diagrams depicting particular embodiments of a digital value sequence of the present invention namely a sequence 400 and a sequence 500. The depicted sequences 400 and 500 are 8 values long and are selected to substantially eliminate all even harmonics as well as a 3^{rd} and a 5^{th} odd harmonic. The depicted sequences substantially cancel approximation errors within a single carrier period and thereby suppress the aforementioned harmonics more the 40 dBc.

The digital value sequence 400 includes 5 unique values while the sequence 500 includes 4 unique values or levels. In the depicted embodiments, the digital value sequences 400 and 500 are time-domain functions that include two symmetric and vertically mirrored sub-sequences that result in a reduced number of unique values. The use of a reduced number of unique values facilitates usage of a low-resolution (high bandwidth) digital-to-analog converter while providing a carrier of good sinusoidal purity. The digital value sequence also includes two repeated values 510. The use of repeated values reduces the number transitions in the synthesized carrier and may reduce transient noise within the digital-to-analog converter.

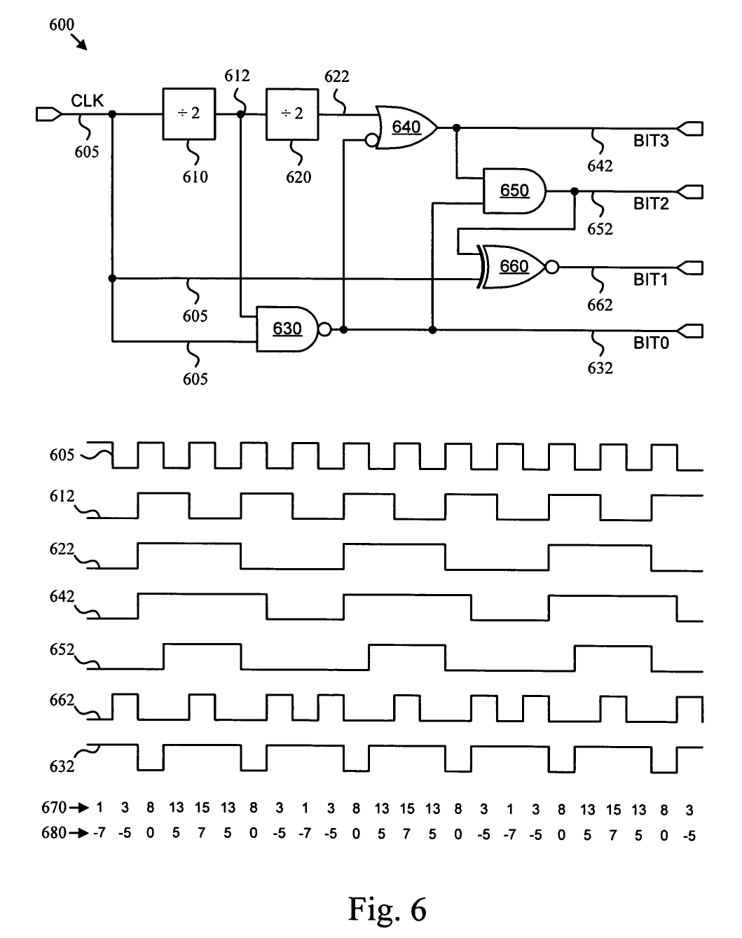

FIG. 6 is a digital logic schematic and associated timing diagram depicting one embodiment of a digital sequencer 600 of the present invention. As depicted, the digital sequencer 600 includes a pair of clock dividers 610 and 620, and various logic gates 630 to 660. In response to a clock signal 605, the digital sequencer 600 provides a sequence of digital values that suppresses multiple unwanted harmonics. One of skill in the art will appreciate that the digital sequencer 600 is depicted in a simplified logical manner and that appropriate delays and other adjustments may be needed to provide a sequencer that functions robustly particularly at the high clock rates achievable by the present invention.

In the depicted embodiment, the digital sequencer 600 is configured to interface with a DAC of at least 4 bits and thereby repeatedly provide a biased sequence 670 comprising the values {8, 13, 15, 13, 8, 3, 1, 3}. The biased sequence 670 has a bias value of 8 and corresponds to an unbiased sequence 680 comprising the values {0, 5, 7, 5, 0, −5, −7, −5}. FIG. 4 depicts the expected harmonic content of a carrier signal corresponding to the digital value sequence generated by the digital sequencer 600.

The clock divider 610 divides the clock signal 605 by two and provides a half rate clock 612 that transitions on the rising edge of the clock signal 605. The clock divider 620 further divides the clock signal 605 by two and provides a quarter rate clock 622 that also transitions in response to the rising edge of the clock signal 605.

The logic gate 630 asserts a negative output when the half rate clock is high and the clock signal 605 is high thus providing a bit0 signal 632 that is asserted as shown in FIG. 6. The logic gate 640 asserts a bit3 signal 642 when either the quarter rate clock 622 is high or the bit0 signal is low. The logic gate 650 asserts a bit2 signal 652 high when the clock signal 605 is high and the bit3 signal is high. Finally, the logic gate 660 asserts a bit1 signal 662 high when the clock signal 605 and the bit2 signal 652 are both high or both low.

The digital sequencer 600 provides the depicted sequence of digital values at very high clock rates. In another embodiment, a state machine is used to provide the depicted sequence. In yet another embodiment, a counter and high speed RAM provide the selected sequence of digital values.

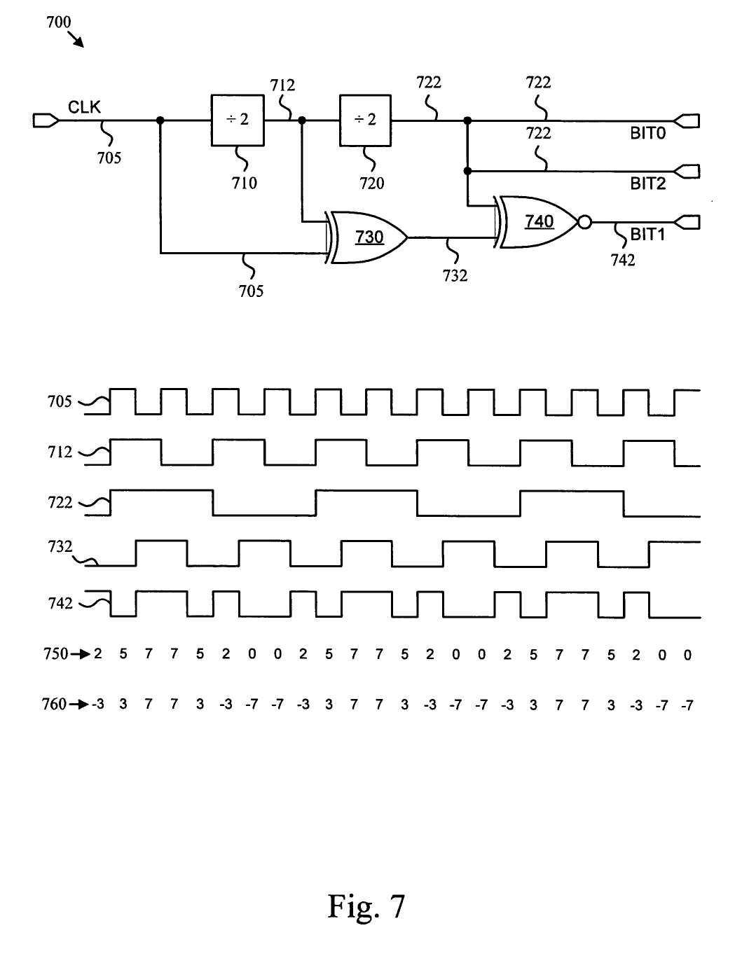

FIG. 7 is a digital logic schematic depicting one embodiment of a digital sequencer 700 of the present invention. As depicted, the digital sequencer 700 includes a pair of clock dividers 710 and 720, and logic gates 730 and 740. In response to a clock signal 705, the digital sequencer 700 provides a sequence of digital values that suppresses multiple unwanted harmonics.

In the depicted embodiment, the digital sequencer 700 is configured to interface with a DAC of at least 3 bits and repeatedly provides a biased sequence 750 comprising the values {5, 7, 7, 5, 2, 0, 0, 2}. The depicted biased sequence 750 has a bias value of 3.5 and corresponds to an unbiased sequence 760 comprising the values (3, 7, 7, 3, −3, −7, −7, −3}. FIG. 5 depicts the expected harmonic content of a carrier signal corresponding to the digital value sequence generated by the digital sequencer 700.

The clock divider 710 divides the clock signal 705 by two and provides a half rate clock 712 that transitions on the rising edge of the clock signal 705. The clock divider 720 further divides the clock signal 705 by two to provide a quarter rate clock 722. The logic gate 730 asserts an output signal 732 when the clock signal 705 is high or the half rate clock 710 is high but not both. Similarly, the logic gate 740 asserts a BIT2 signal 742 low when the quarter rate clock 722 is high or the output signal 732 is high but not both.

Although the biased sequence 750 provided by the digital sequencer 700 requires only 3 bits of resolution, the corresponding unbiased sequence 760 provides 4 bits of resolution and suppresses the 3^{rd} harmonic and 5^{th} harmonic by more than 40 dBc (see FIG. 5). As such, the digital sequencer 700 provides more than 14 dB of suppression per sequencer bit for all harmonics between 1 and N-1—a truly remarkable result.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for synthesizing a sinusoidal carrier, the method comprising:
providing a sequence of N digital values;
repeatedly converting the sequence of N digital values to a stream of quantized analog samples; and
wherein the sequence of N digital values comprise a time-domain function selected to substantially eliminate all even harmonics and a plurality of odd harmonics from the stream of quantized analog samples.

2. The method of claim 1, further comprising providing the sequence of N digital values in response to a programmable clock.

3. The method of claim 1, further comprising filtering the stream of quantized analog samples to provide a substantially pure sinusoidal waveform.

4. The method of claim 1, wherein the plurality of odd harmonics comprises all odd harmonics between 1 and N-1.

5. The method of claim 4, wherein the plurality of odd harmonics are suppressed more than 12 dB per bit of resolution within the digital values.

6. The method of claim 1, wherein the sequence of N digital values comprises at least one repeated value.

7. The method of claim 1, wherein the sequence of N digital values comprises less than N/2 unique values.

8. The method of claim 1, wherein the sequence of N digital values comprises a plurality of reused values.

9. The method of claim 1, wherein the plurality of odd harmonics include a 3^{rd} and a 5^{th} harmonic.

10. The method of claim 1, wherein the sequence of N digital values comprises two symmetric vertically mirrored sub-sequences.

11. The method of claim 1, wherein each harmonic of the plurality of odd harmonics is at least 30 dB below a first harmonic.

12. The method of claim 1, wherein the stream of quantized analog samples comprises samples with less than 6 bits of resolution.

13. The method of claim 1, wherein the stream of quantized analog samples comprises samples with less than 4 bits of resolution.

14. The method of claim 1, further comprising modulating an input waveform with the sequence of digital values.

15. The method of claim 1, wherein the sequence of digital values corresponds to an unbiased sequence selected from the group consisting of {3,7,7,3,−3,−7,−7,−3}, {0,5,7,5,0,−5,−7,−5}, and {0,7,10,7,0,−7,−10,−7}.

16. The method of claim 1, wherein N is less than 17.

17. A method for synthesizing a sinusoidal carrier, the method comprising:
providing a sequence of N digital values in response to a programmable clock wherein the sequence of N digital values comprises at least one repeated value and wherein the sequence of N digital values comprise a time-domain function selected to substantially eliminate all odd harmonics between 1 and N-1 and all even harmonics from the stream of quantized analog samples;
repeatedly converting the sequence of N digital values to a stream of quantized analog samples; and
filtering the stream of quantized analog samples to provide a substantially pure sinusoidal waveform.

18. An apparatus for synthesizing a sinusoidal carrier, the apparatus comprising:
a digital sequencer configured to repeatedly provide a sequence of N digital values;
an digital-to-analog converter configured to repeatedly convert the sequence of N digital values to a stream of quantized analog samples; and
wherein the sequence of N digital values comprise a time-domain function selected to substantially eliminate all even harmonics and a plurality of odd harmonics from the stream of quantized analog samples.

19. The apparatus of claim 18, further comprising a programmable clock configured to control a sequence rate of the digital sequencer.

20. The apparatus of claim 18, further comprising a filter configured to filter the stream of quantized analog samples to provide a substantially pure sinusoidal waveform.

21. The apparatus of claim 18, wherein the plurality of odd harmonics comprises all odd harmonics between 1 and N-1.

22. The apparatus of claim 21, wherein the plurality of odd harmonics are suppressed more than 12 dB per digital sequencer bit.

23. The apparatus of claim 18, wherein the sequence of N digital values comprises at least one repeated value.

24. The apparatus of claim 18, wherein the sequence of N digital values comprises less than N/2 unique values.

25. The apparatus of claim 18, wherein the sequence of N digital values comprises a plurality of reused values.

26. The apparatus of claim 18, wherein the plurality of odd harmonics include a 3^{rd} and a 5^{th} harmonic.

27. The apparatus of claim 18, wherein the sequence of N digital values comprises two symmetric vertically mirrored sub-sequences.

28. The apparatus of claim 18, wherein each harmonic of the plurality of odd harmonics is at least 30 dB below a first harmonic.

29. The apparatus of claim 18, wherein the stream of quantized analog samples comprises samples with less than 6 bits of resolution.

30. The apparatus of claim 18, wherein the stream of quantized analog samples comprises samples with less than 4 bits of resolution.

31. The apparatus of claim 18, wherein the digital-to-analog converter is further configured to modulate an input waveform with the sequence of digital values.

32. The apparatus of claim 18, wherein the sequence of digital values corresponds to an unbiased sequence selected from the group consisting of {3,7,7,3,−3,−7,−7,−3}, {0,5,7,5,0,−5,−7,−5}, and {0,7,10,7,0,−7,−10,−7}.

33. The apparatus of claim 18, wherein N is less than 17.

34. An apparatus for synthesizing a sinusoidal carrier, the apparatus comprising:
a digital sequencer configured to repeatedly provide a sequence of N digital values wherein the sequence of N digital values comprises at least one repeated value and wherein the sequence of N digital values comprise a time-domain function selected to substantially eliminate all odd harmonics between 1 and N-1 and all even harmonics from the stream of quantized analog samples;
a programmable clock configured to control a sequence rate of the digital sequencer;
an digital-to-analog converter configured to repeatedly convert the sequence of N digital values to a stream of quantized analog samples; and
wherein the sequence of N digital values comprise a time-domain function selected to substantially eliminate all even harmonics and a plurality of odd harmonics from the stream of quantized analog samples.

35. A method for synthesizing a sinusoidal carrier, the method comprising:
providing a sequence of N digital values;
repeatedly converting the sequence of N digital values to a stream of quantized analog samples; and
wherein the sequence of N digital values comprise a time-domain function selected to substantially cancel carrier approximation errors over a single carrier period.

36. The method of claim 35, further comprising providing the sequence of N digital values in response to a programmable clock.

37. The method of claim 35, wherein the plurality of odd harmonics comprises all odd harmonics between 1 and N-1.

38. The method of claim 37, wherein the plurality of odd harmonics are suppressed more than 12 dB per bit of resolution within the digital values.

39. The method of claim 35, wherein the sequence of N digital values comprises less than N/2 unique values.

40. The method of claim 35, wherein the stream of quantized analog samples comprises samples with less than 4 bits of resolution.

41. An apparatus for synthesizing a sinusoidal carrier, the apparatus comprising:
a digital sequencer configured to repeatedly provide a sequence of N digital values;
an digital-to-analog converter configured to repeatedly convert the sequence of N digital values to a stream of quantized analog samples; and
wherein the sequence of N digital values comprise a time-domain function selected to substantially cancel carrier approximation errors over a single carrier period.

42. The apparatus of claim 41, further comprising a programmable clock configured to control a sequence rate of the digital sequencer.

43. The method of claim 41, wherein the plurality of odd harmonics comprises all odd harmonics between 1 and N-1.

44. The method of claim 43, wherein the plurality of odd harmonics are suppressed more than 12 dB per bit of resolution within the digital values.

45. The method of claim 41, wherein the sequence of N digital values comprises less than N/2 unique values.

46. The method of claim 1, wherein the stream of quantized analog samples comprises samples with less than 4 bits of resolution.
